(19) United States
(12) Patent Application Publication
(10) Pub. No.: US 2013/0265849 A1
(43) Pub. Date: Oct. 10, 2013

(54) METHODS AND DEVICES FOR ENHANCED SURVEY DATA COLLECTION

(71) Applicant: WESTERNGECO L.L.C., Houston, TX (US)

(72) Inventor: Timothy Bunting, Rio De Jainero (BR)

(73) Assignee: Westerngeco L.L.C., HOUSTON, TX (US)

(21) Appl. No.: 13/689,583

(22) Filed: Nov. 29, 2012

Related U.S. Application Data
(60) Provisional application No. 61/620,120, filed on Apr. 4, 2012.

(51) Int. Cl. G01V 1/38

(52) U.S. Cl. CPC G01V 1/3826
USPC 367/16

(57) ABSTRACT

Methods and computing systems are disclosed for enhancing survey data collection. In one embodiment, a method is performed that includes deploying an array of marine seismic streamers, wherein respective streamers in the array include a plurality of seismic receivers; towing the array of marine seismic streamers; actively steering the array of marine seismic streamers; and while actively steering the array of marine seismic streamers, maintaining a tow-depth profile for the array such that the plurality of seismic receivers are configured to acquire seismic data having a receiver ghost response frequency that varies linearly.

### CROSS-REFERENCE TO RELATED APPLICATION

This application claims the benefit of U.S. Provisional Patent Application Ser. No. 61/620,120 filed Apr. 4, 2012, which is incorporated herein by reference in its entirety.

### BACKGROUND

Various types of noise are encountered in seismic surveys, including multiple reflections, or “multiples” for short. Typical multiples are reverberations within a low-velocity zone, such as between the sea surface and sea bottom. Water-air interfaces, i.e., the sea's surface, can reflect a seismic wave and cause a downward reflection. Moreover, source-receiver geometry may produce short path multiples returning downward from the sea's surface, which are sometimes called ghosts. The ghost has a frequency dependent response which both constructively and destructively interferes with the primary signal. The ghost response is directly related to the travel time difference between the primary and ghost signal. At a certain frequency, called the ghost notch frequency, the primary and ghost signal will cancel out, leaving the seismic record virtually devoid of signal amplitude. As a general rule, varying the distance between a receiver and the reflector (e.g., the sea surface) that generates the ghost can move the ghost notch with respect to a given frequency (and/or modify the frequency response of the ghost). As the travel time difference between the primary and ghost signal changes as a function of source to receiver offset, a constant depth streamer will have a ghost response which changes as a function of offset.

Existing approaches attempt to increase the diversity of the ghost response as a function of offset, and thus reduce the impact of the ghost notch, by modifying the cable depth by using constant-gradient streamer shapes, or by using curved cable shapes which flatten with increased offset. While these techniques can increase the diversity of the notch response over certain offset ranges, the rate of change of the ghost response is not constant, resulting in less variation in ghost notch diversity over certain offset ranges.

As such, it can be helpful to choose survey operational parameters, such as streamer depths and configurations, so as to vary the ghost notch linearly as a function of source to detector offset or as a function of target reflection incident angle.

### SUMMARY

In accordance with some embodiments, a method is performed that includes deploying an array of marine seismic streamers, wherein respective streamers in the array include a plurality of seismic receivers; towing the array of marine seismic streamers; actively steering the array of marine seismic streamers; and while actively steering the array of marine seismic streamers, maintaining a tow-depth profile for the array such that the plurality of seismic receivers are configured to acquire seismic data having a receiver ghost response frequency that varies linearly.

In accordance with some embodiments, a computing system is provided that includes at least one processor, at least one memory, and one or more programs stored in the at least one memory, wherein the one or more programs are configured to be executed by the one or more processors, the one or more programs including instructions for deploying an array of marine seismic streamers, wherein respective streamers in the array include a plurality of seismic receivers; towing the array of marine seismic streamers; actively steering the array of marine seismic streamers; and while actively steering the array of marine seismic streamers, maintaining a tow-depth profile for the array such that the plurality of seismic receivers are configured to acquire seismic data having a receiver ghost response frequency that varies linearly.

In accordance with some embodiments, a computer readable storage medium is provided, the medium having a set of one or more programs including instructions that when executed by a computing system cause the computing system to deploy an array of marine seismic streamers, wherein respective streamers in the array include a plurality of seismic receivers; tow the array of marine seismic streamers; actively steering the array of marine seismic streamers; and while actively steering the array of marine seismic streamers, maintain a tow-depth profile for the array such that the plurality of seismic receivers are configured to acquire seismic data having a receiver ghost response frequency that varies linearly.

In accordance with some embodiments, a computing system is provided that includes at least one processor, at least one memory, and one or more programs stored in the at least one memory; and means for deploying an array of marine seismic streamers, wherein respective streamers in the array include a plurality of seismic receivers; means for towing the array of marine seismic streamers; actively steering the array of marine seismic streamers; and while actively steering the array of marine seismic streamers, means for maintaining a tow-depth profile for the array such that the plurality of seismic receivers are configured to acquire seismic data having a receiver ghost response frequency that varies linearly.

In accordance with some embodiments, an information processing apparatus for use in a computing system is provided, and includes means for deploying an array of marine seismic streamers, wherein respective streamers in the array include a plurality of seismic receivers; means for towing the array of marine seismic streamers; actively steering the array of marine seismic streamers; and while actively steering the array of marine seismic streamers, means for maintaining a tow-depth profile for the array such that the plurality of seismic receivers are configured to acquire seismic data having a receiver ghost response frequency that varies linearly.

In accordance with some embodiments, a method is performed that includes: determining a first rate of tow-depth change for a first location on a marine streamer, wherein the first rate of tow-depth change is configured to maintain a first rate of ghost notch frequency change in seismic data acquired at the first location; and based at least in part on the first rate of tow-depth change, determining a tow depth for a second location on the marine streamer.

In accordance with some embodiments, a computing system is provided that includes at least one processor, at least one memory, and one or more programs stored in the at least one memory, wherein the one or more programs are configured to be executed by the one or more processors, the one or more programs including instructions for determining a first rate of tow-depth change for a first location on a marine streamer, wherein the first rate of tow-depth change is configured to maintain a first rate of ghost notch frequency change in seismic data acquired at the first location; and based at least in part on the first rate of tow-depth change, determining a tow depth for a second location on the marine streamer.

In accordance with some embodiments, a computer readable storage medium is provided, the medium having a set of one or more programs including instructions that when executed by a computing system cause the computing system to determine a first rate of tow-depth change for a first location on a marine streamer, wherein the first rate of tow-depth change is configured to maintain a first rate of ghost notch frequency change in seismic data acquired at the first location; and based at least in part on the first rate of tow-depth change, determine a tow depth for a second location on the marine streamer.

In accordance with some embodiments, a computing system is provided that includes at least one processor, at least one memory, and one or more programs stored in the at least one memory; and means for determining a first rate of tow-depth change for a first location on a marine streamer, wherein the first rate of tow-depth change is configured to maintain a first rate of ghost notch frequency change in seismic data acquired at the first location; and based at least in part on the first rate of tow-depth change, means for determining a tow depth for a second location on the marine streamer.

In accordance with some embodiments, an information processing apparatus for use in a computing system is provided, and includes means for determining a first rate of tow-depth change for a first location on a marine streamer, wherein the first rate of tow-depth change is configured to maintain a first rate of ghost notch frequency change in seismic data acquired at the first location; and based at least in part on the first rate of tow-depth change, means for determining a tow depth for a second location on the marine streamer.

In accordance with some embodiments, a method is performed that includes calculating a curved shape profile for at least part of a towed marine seismic streamer, wherein the curved shape profile includes a plurality of tow depths corresponding to respective positions on the towed marine seismic streamer, respective rates of tow-depth change are determined for respective positions on the towed marine seismic streamer, wherein the determined respective rates of tow-depth change are configured to maintain respective rates of ghost notch frequency changes in seismic data acquired at respective locations on the towed marine seismic streamer, and respective tow depths in the plurality of tow depths are determined based at least in part on the respective rates of tow-depth change.

In accordance with some embodiments, a computing system is provided that includes at least one processor, at least one memory, and one or more programs stored in the at least one memory, wherein the one or more programs are configured to be executed by the one or more processors, the one or more programs including instructions for calculating a curved shape profile for at least part of a towed marine seismic streamer, wherein the curved shape profile includes a plurality of tow depths corresponding to respective positions on the towed marine seismic streamer, respective rates of tow-depth change are determined for respective positions on the towed marine seismic streamer, wherein the determined respective rates of tow-depth change are configured to maintain respective rates of ghost notch frequency changes in seismic data acquired at respective locations on the towed marine seismic streamer, and respective tow depths in the plurality of tow depths are determined based at least in part on the respective rates of tow-depth change

In accordance with some embodiments, a computer readable storage medium is provided, the medium having a set of one or more programs including instructions that when executed by a computing system cause the computing system to calculate a curved shape profile for at least part of a towed marine seismic streamer, wherein the curved shape profile includes a plurality of tow depths corresponding to respective positions on the towed marine seismic streamer, respective rates of tow-depth change are determined for respective positions on the towed marine seismic streamer, wherein the determined respective rates of tow-depth change are configured to maintain respective rates of ghost notch frequency changes in seismic data acquired at respective locations on the towed marine seismic streamer, and respective tow depths in the plurality of tow depths are determined based at least in part on the respective rates of tow-depth change.

In accordance with some embodiments, a computing system is provided that includes at least one processor, at least one memory, and one or more programs stored in the at least one memory; and means for calculating a curved shape profile for at least part of a towed marine seismic streamer, wherein the curved shape profile includes a plurality of tow depths corresponding to respective positions on the towed marine seismic streamer, respective rates of tow-depth change are determined for respective positions on the towed marine seismic streamer, wherein the determined respective rates of tow-depth change are configured to maintain respective rates of ghost notch frequency changes in seismic data acquired at respective locations on the towed marine seismic streamer, and respective tow depths in the plurality of tow depths are determined based at least in part on the respective rates of tow-depth change.

In accordance with some embodiments, an information processing apparatus for use in a computing system is provided, and includes means for calculating a curved shape profile for at least part of a towed marine seismic streamer, wherein the curved shape profile includes a plurality of tow depths corresponding to respective positions on the towed marine seismic streamer, respective rates of tow-depth change are determined for respective positions on the towed marine seismic streamer, wherein the determined respective rates of tow-depth change are configured to maintain respective rates of ghost notch frequency changes in seismic data acquired at respective locations on the towed marine seismic streamer, and respective tow depths in the plurality of tow depths are determined based at least in part on the respective rates of tow-depth change.

In some embodiments, the computing system includes a streamer shape profile module for determining, calculating, estimating, and/or deriving a tow-depth profile that configures a streamer with a plurality of seismic receivers to acquire seismic data having a receiver ghost response frequency that varies linearly.

In some embodiments, the computing system includes a streamer shape profile module, which alone or in conjunction with other parts of the computing system, determines, calculates, estimates, and/or derives a curved shape profile for a streamer in a plurality of streamers.

In some embodiments, an aspect of the invention includes that the receiver ghost response frequency varies linearly as a function of an offset between a seismic source and the plurality of seismic receivers.

In some embodiments, an aspect of the invention includes that the receiver ghost response frequency varies linearly as a function of an incident angle of ray paths between a seismic source and the plurality of seismic receivers.

In some embodiments, an aspect of the invention includes that the receiver ghost response frequency varies linearly as a first function of an offset between a seismic source and a first subset of seismic receivers in the plurality of seismic receivers.

In some embodiments, an aspect of the invention includes that the receiver ghost response frequency varies linearly as a second function of an offset between the seismic source and a second subset of seismic receivers in the plurality of seismic receivers.

In some embodiments, an aspect of the invention includes that the receiver ghost response frequency varies linearly as a first function of an incident angle of ray paths between a seismic source and a first subset of seismic receivers in the plurality of seismic receivers.

In some embodiments, an aspect of the invention includes that the receiver ghost response frequency varies as a second function of incident angle of ray paths between the seismic source and a second subset of seismic receivers in the plurality of seismic receivers.

In some embodiments, an aspect of the invention includes that the acquired seismic data includes a linear gradient corresponding to the frequency notch for the receiver ghost response frequency, the linear gradient is substantially equivalent to a first value for a first subset of seismic receivers in the plurality of seismic receivers, and the linear gradient is substantially equivalent to a second, different value for a second subset of seismic receivers in the plurality of seismic receivers.

In some embodiments, an aspect of the invention includes that the receiver ghost response frequency is in an acquisition domain.

In some embodiments, an aspect of the invention includes that the respective rates of tow-depth change are determined based at least in part on a function of an incident angle of ray paths between a seismic source and respective positions on the towed marine seismic streamer.

In some embodiments, an aspect of the invention includes that the respective rates of tow-depth change are determined based at least in part on a function of an offset between a seismic source and respective positions on the towed marine seismic streamer.

### BRIEF DESCRIPTION OF THE DRAWINGS

For a better understanding of the aforementioned embodiments as well as additional embodiments thereof, reference should be made to the Description of Embodiments below, in conjunction with the following drawings in which like reference numerals refer to corresponding parts throughout the figures.

FIGS. 1A through 1P illustrate varying marine survey configurations in accordance with some embodiments.

FIG. 2 is an example plot illustrating an offset dependent receiver depth required to maintain a ghost response that increases linearly as a function of offset.

FIG. 3 is a flow diagram illustrating a streamer shape estimation method in accordance with some embodiments.

FIGS. 4 and 5 are curved shape streamer profiles in accordance with some embodiments.

FIG. 6 illustrates a computing system in accordance with some embodiments.

FIGS. 7A, 7B, 8, and 9 are flow diagrams illustrating various methods in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

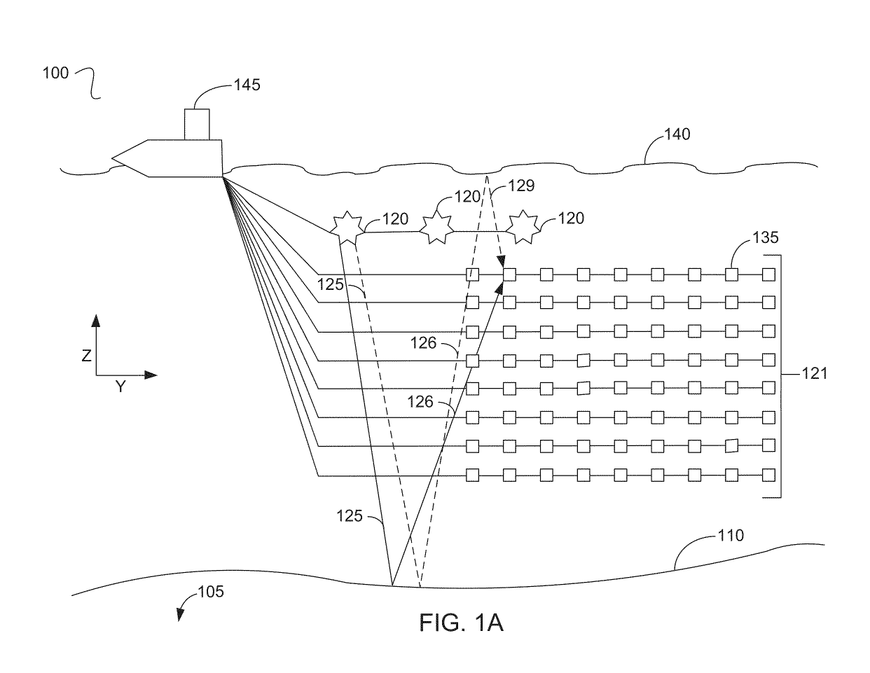

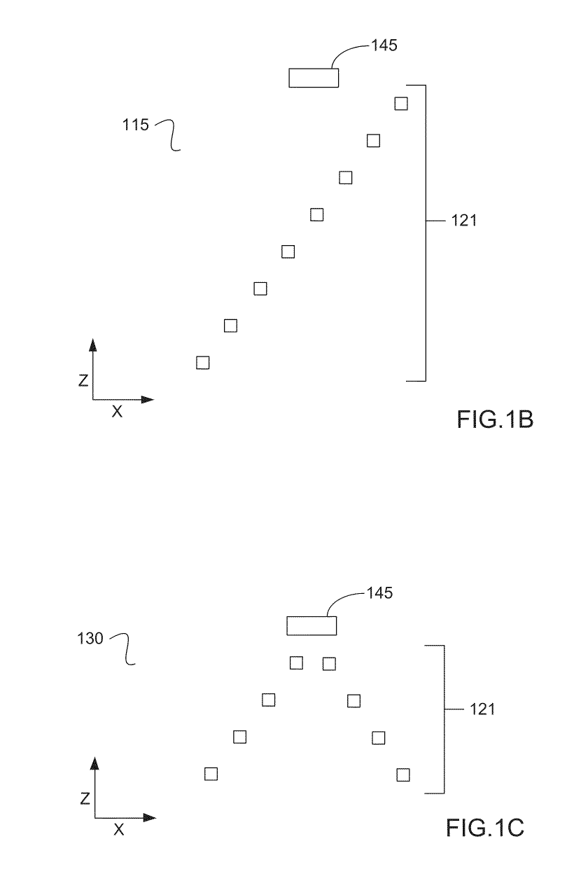

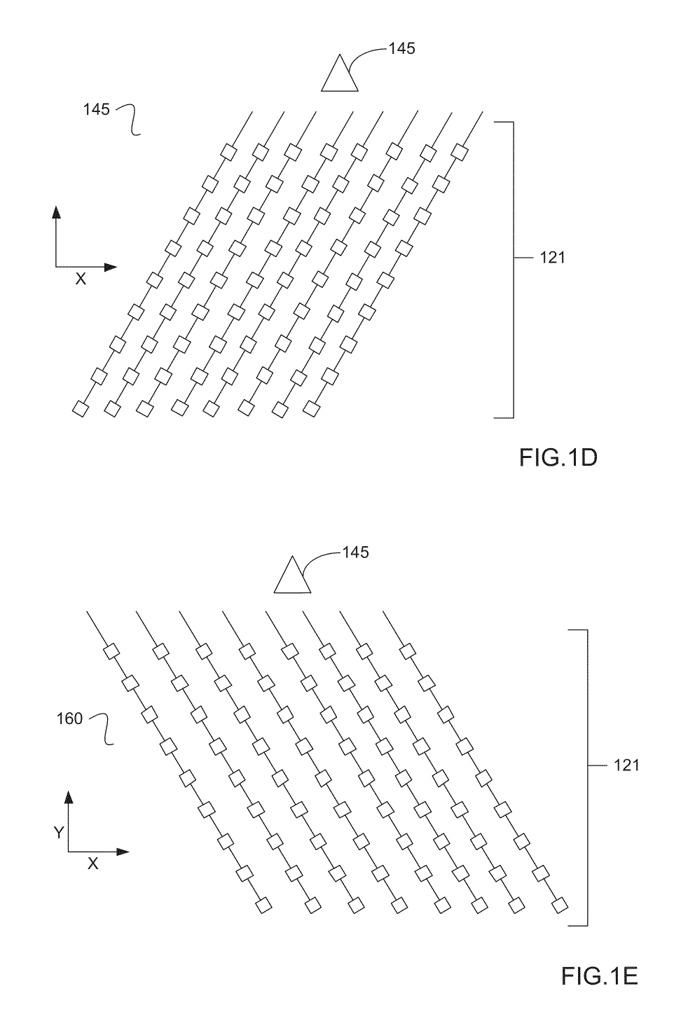

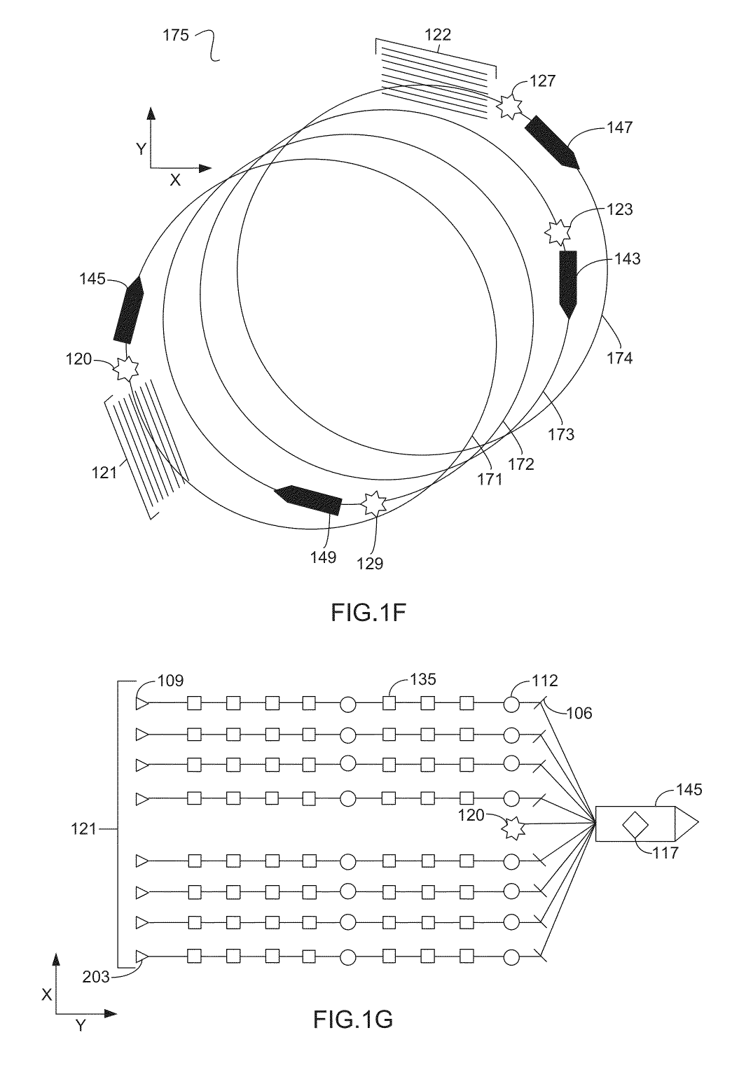

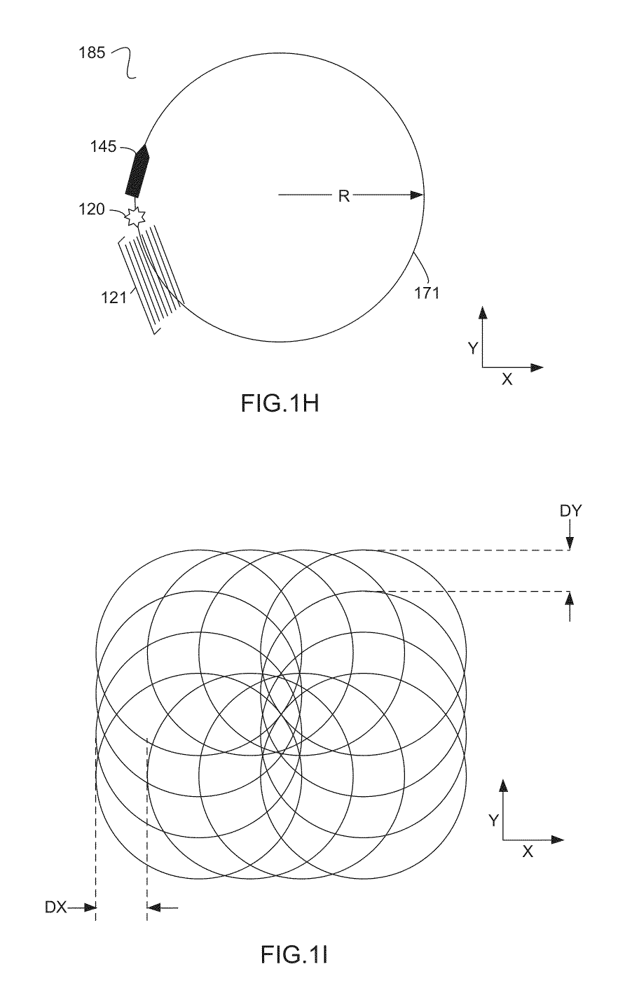

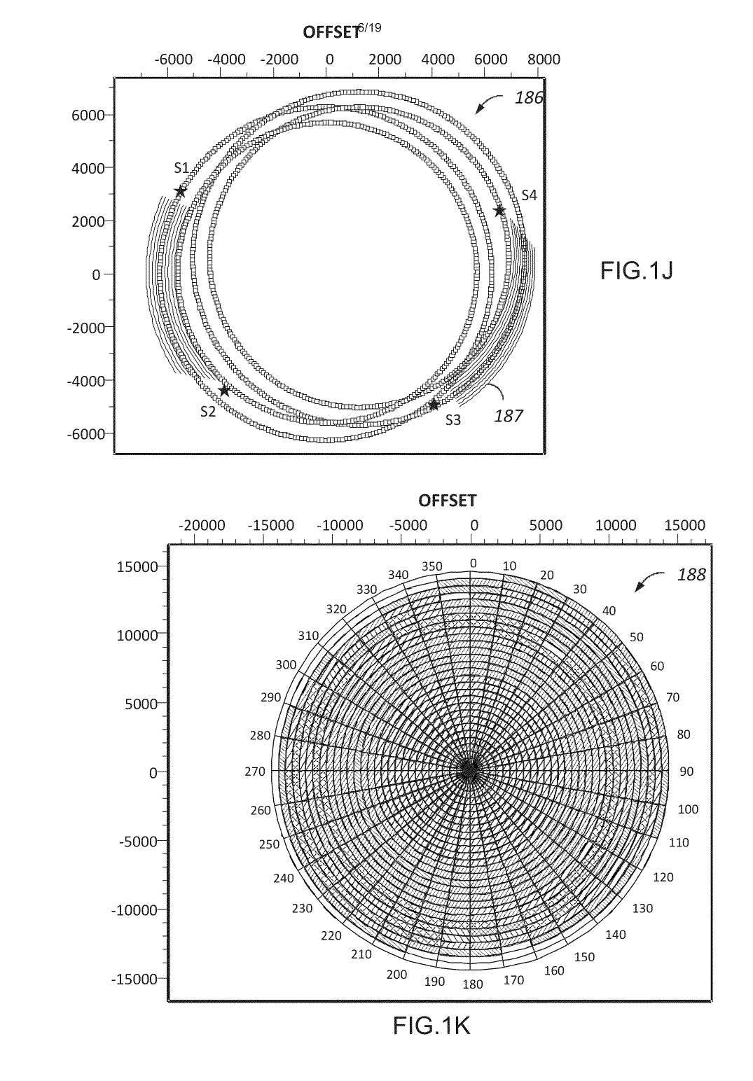

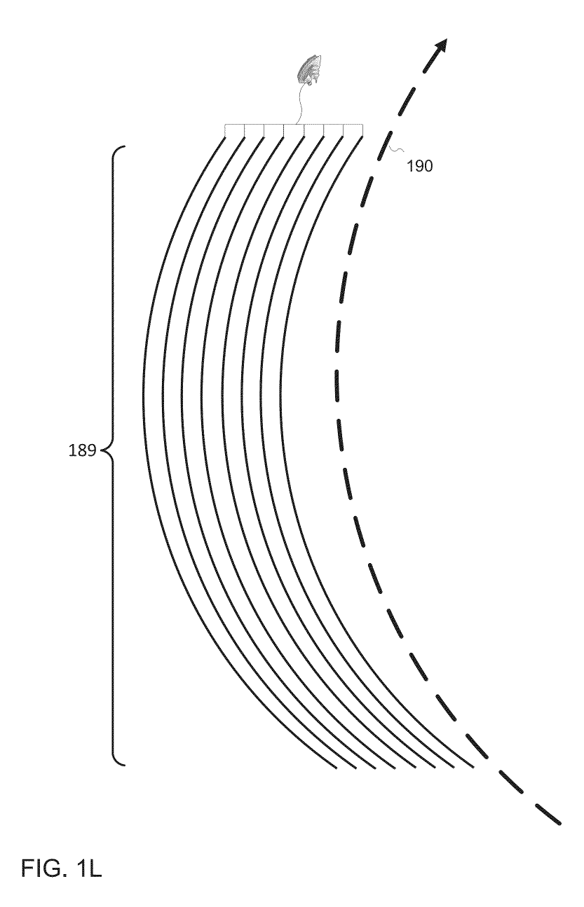

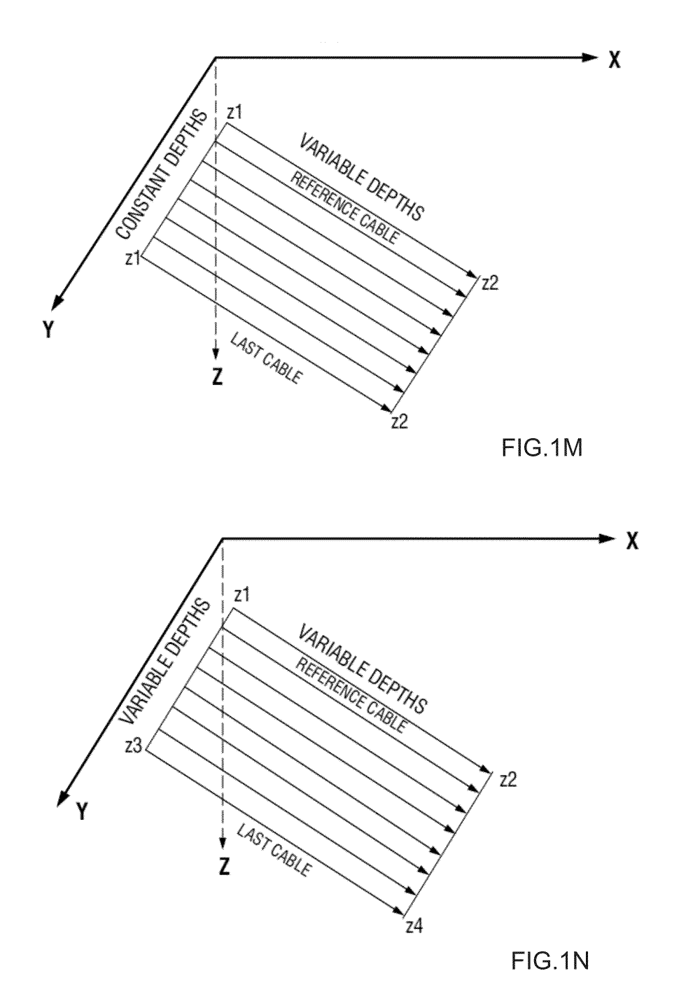

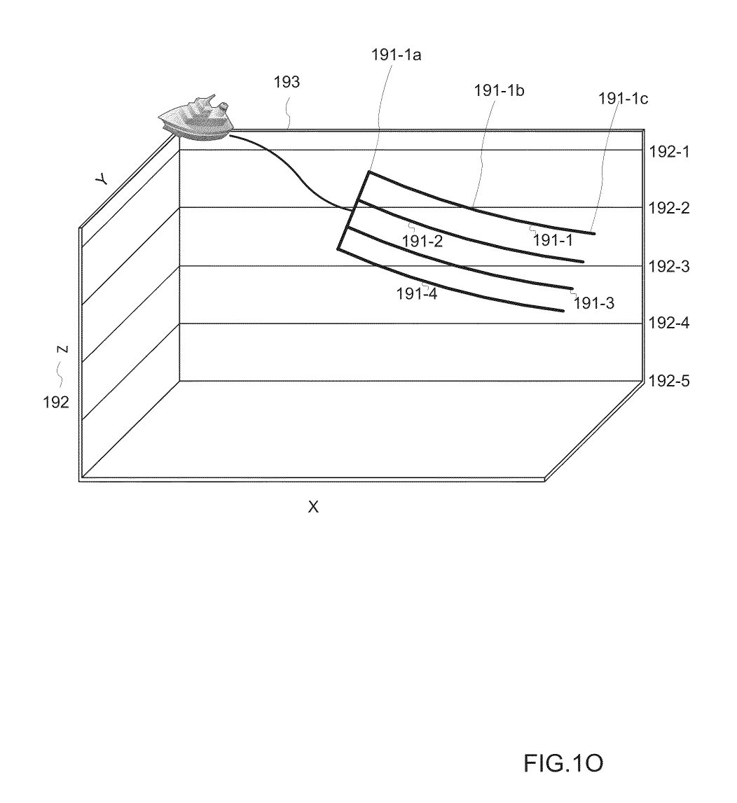

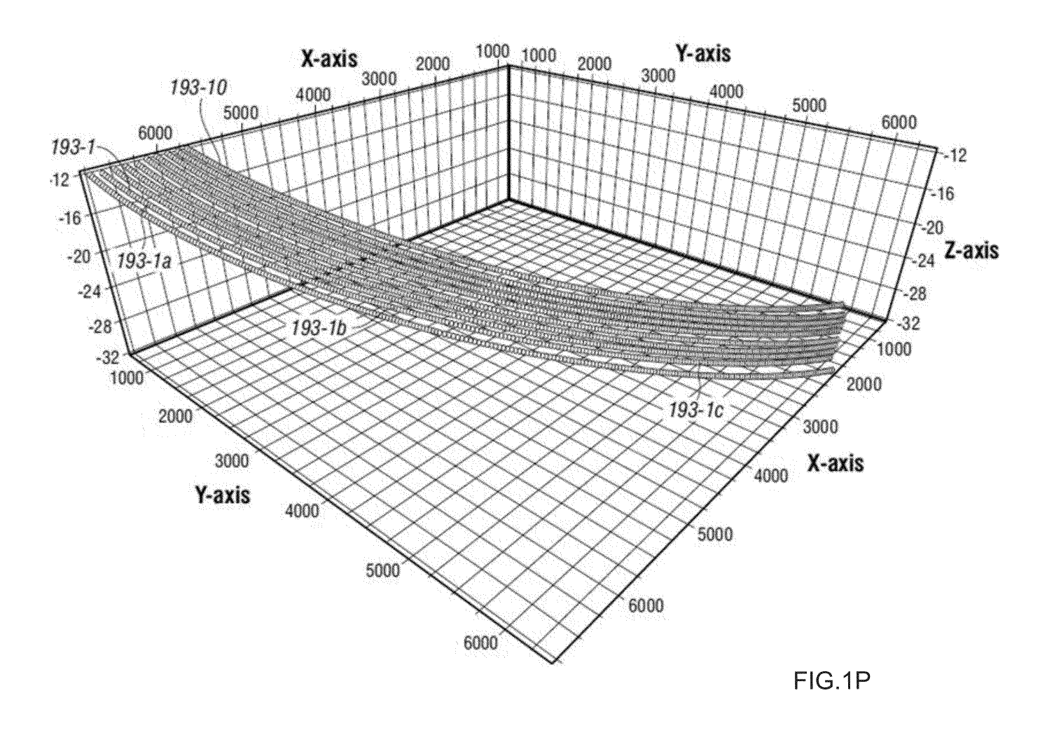

Attention is now directed to FIGS. 1A-1P, which illustrate marine survey configurations in accordance with varying embodiments.

### Multiple Streamer/Multiple Depth Survey Configuration

FIG. 1A illustrates a side view of a marine-based survey 100 of a subterranean subsurface 105 in accordance with one or more implementations of various techniques described herein. Subsurface 105 includes seafloor surface 110. Seismic sources 120 may include marine vibroseis sources, which may propagate seismic waves 125 (e.g., energy signals) into the Earth over an extended period of time or at a nearly instantaneous energy provided by impulsive sources. The seismic waves may be propagated by marine vibroseis sources as a frequency sweep signal. For example, the marine vibroseis sources may initially emit a seismic wave at a low frequency (e.g., 5 Hz) and increase the seismic wave to a high frequency (e.g., 80-90 Hz) over time.

The component(s) of the seismic waves 125 may be reflected and converted by seafloor surface 110 (i.e., reflector), and seismic wave reflections 126 may be received by a plurality of seismic receivers 135. Seismic receivers 135 may be disposed on a plurality of streamers (i.e., streamer array 121). The seismic receivers 135 may generate electrical signals representative of the received seismic wave reflections 126. The electrical signals may be embedded with information regarding the subsurface 105 and captured as a record of seismic data.

In one implementation, each streamer may include streamer steering devices such as a bird, a deflector, a tail buoy and the like. The streamer steering devices may be used to control the position of the streamers in accordance with the techniques described herein. The bird, the deflector and the tail buoy is described in greater detail with reference to FIG. 1G below.

In one implementation, seismic wave reflections 126 may travel upward and reach the water/air interface at the water surface 140, a majority portion of reflections 126 may then reflect downward again (i.e., sea-surface ghost waves 129) and be received by the plurality of seismic receivers 135. The sea-surface ghost waves 129 may be referred to as surface multiples. The point on the water surface 140 at which the wave is reflected downward is generally referred to as the downward reflection point.

The electrical signals may be transmitted to a vessel 145 via transmission cables, wireless communication or the like. The vessel 145 may then transmit the electrical signals to a data processing center. Alternatively, the vessel 145 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 135. In one implementation, the seismic data may be processed to generate a seismic image of the subsurface 105.

Typically, marine seismic acquisition systems tow each streamer in streamer array 121 at the same depth (e.g., 5-10 m). However, marine based survey 100 may tow each streamer in streamer array 121 at different depths such that seismic data may be acquired and processed in a manner that avoids the effects of destructive interference due to sea-surface ghost waves. For instance, marine-based survey 100 of FIG. 1A illustrates eight streamers towed by vessel 145 at eight different depths. The depth of each streamer may be controlled and maintained using the birds disposed on each streamer. In one implementation, streamers can be arranged in increasing depths such that the leftmost streamer is the deepest streamer and the rightmost streamer is the shallowest streamer or vice versa. (See FIG. 1B).

Alternatively, the streamers may be arranged in a symmetric manner such that the two middle streamers are towed at the same depth; the next two streamers outside the middle streamers are towed at the same depth that is deeper than the middle streamers and so on. (See FIG. 1C). In this case, the streamer distribution would be shaped as an inverted V. Although marine survey 100 has been illustrated with eight streamers, in other implementations marine survey 100 may include any number of streamers.

In addition to towing streamers at different depths, each streamer of a marine-based survey may be slanted from the inline direction, while preserving a constant streamer depth. (See FIG. 1D and FIG. 1E). In one implementation, the slant of each streamer may be obtained and maintained using the deflector and/or the tail buoy disposed on each streamer. The angle of the slant may be approximately 5-6 degrees from the inline direction. The angle of the slant may be determined based on the size of the subsurface bins. A subsurface bin may correspond to a certain cell or bin within the subsurface of the earth, typically 25 m long by 25 m wide, where seismic surveys acquire the seismic data used to create subsurface images. In this manner, the slant angle may be larger for larger subsurface bin sizes and may be smaller for smaller subsurface bin sizes. The slant may be used to acquire seismic data from several locations across a streamer such that sea-surface ghost interference may occur at different frequencies for each receiver.

### Multiple Streamer/Multiple Depth Coil Survey Configuration

In another implementation, streamers may be towed at different depths and towed to follow circular tracks such as that of a coil survey. (See FIGS. 1F, 1H & 1I). In one implementation, the coil survey may be performed by steering a vessel in a spiral path (See FIG. 1I). In another implementation, the coil survey may be performed by towing multiple vessels in a spiral path such that a first set of vessels tow just sources and a second set of vessels tow both sources and streamers. The streamers here may also be towed at various depths. For instance, the streamers may be arranged such that the leftmost streamer is the deepest streamer and the rightmost streamer is the shallowest streamer, or vice versa. The streamers may also be arranged such that they form a symmetrical shape (e.g., inverted V shape). Like the implementations described above, each streamer of the coil survey may also be slanted approximately from the inline direction, while preserving a constant streamer depth. Additional details with regard to multi-vessel coil surveys may be found in U.S. Patent Application Publication No. 2010/0142317 (which is hereby incorporated by reference in its entirety), and in the discussion below with reference to FIGS. 1F-1G.

FIG. 1F illustrates an aerial view of a multi-vessel marine-based coil survey 175 of a subterranean subsurface in accordance with one or more implementations of various techniques described herein. Coil survey 175 illustrated in FIG. 1F is provided to illustrate an example of how a multi-vessel coil survey 175 may be configured. However, it should be understood that multi-vessel coil survey 175 is not limited to the example described herein and may be implemented in a variety of different configurations.

Coil survey 175 may include four survey vessels 143/145/147/149, two streamer arrays 121/122, and a plurality of sources 120/123/127/129. The vessels 145/147 are “receiver vessels” in that they each tow one of the streamer arrays 121/122, although they also tow one of the sources 120/127. Because the receiver vessels 145/147 also tow sources 120/127, the receiver vessels 145/147 are sometimes called “streamer/source” vessels or “receiver/source” vessels. In one implementation, the receiver vessels 145/147 may omit sources 120/127. Receiver vessels are sometimes called “streamer only” vessels if they tow streamer arrays 121/122 and do not tow sources 120/127. Vessels 143/149 are called “source vessels” since they each tow a respective source or source array 123/129 but no streamer arrays. In this manner, vessels 143/149 may be called “source only” vessels.

Each streamer array 121/122 may be “multicomponent” streamers. Examples of suitable construction techniques for multicomponent streamers may be found in U.S. Pat. No. 6,477,711, U.S. Pat. No. 6,671,223, U.S. Pat. No. 6,684,160, U.S. Pat. No. 6,932,017, U.S. Pat. No. 7,080,607, U.S. Pat. No. 7,293,520, and U.S. Patent Application Publication 2006/0239117 (each of which is hereby incorporated by reference in its entirety, respectively). Any of these alternative multicomponent streamers may be used in conjunction with the techniques described herein.

FIG. 1G illustrates an aerial view of a streamer array 121 in a marine-based coil survey 175 in accordance with one or more implementations of various techniques described herein.

Vessel 145 may include computing apparatus 117 that controls streamer array 121 and source 120 in a manner well known and understood in the art. The towed array 121 may include any number of streamers. In one implementation, a deflector 106 may be attached to the front of each streamer. A tail buoy 109 may be attached at the rear of each streamer. Deflector 106 and tail buoy 109 may be used to help control the shape and position of the streamer. In one implementation, deflector 106 and tail buoy 109 may be used to actively steer the streamer to the slant as described above with reference to FIGS. 1D-1E.

A plurality of seismic cable positioning devices known as “birds” 112 may be located between deflector 106 and tail buoy 109. Birds 112 may be used to actively steer or control the depth at which the streamers are towed. In this manner, birds 112 may be used to actively position the streamers in various depth configurations such as those described above with reference to FIGS. 1B-1C.

In one implementation, sources 120 may be implemented as arrays of individual sources. As mentioned above with reference to FIG. 1A, sources 120 may include marine vibroseis sources using any suitable technology known to the art, such as impulse sources like explosives, air guns, and vibratory sources. One suitable source is disclosed in U.S. Pat. No. 4,657,482 (which is hereby incorporated by reference in its entirety). In one implementation, sources 120 may simultaneously propagate energy signals. The seismic waves from sources 120 may then be separated during subsequent analysis.

In order to perform a coil survey (e.g., FIG. 1F/1H), the relative positions of vessels 143/145/147/149, as well as the shapes and depths of the streamers 121/122, may be maintained while traversing the respective sail lines 171-174 using control techniques known to the art. Any suitable technique known to the art may be used to control the shapes and depths of the streamers such as those disclosed in commonly assigned U.S. Pat. No. 6,671,223, U.S. Pat. No. 6,932,017, U.S. Pat. No. 7,080,607, U.S. Pat. No. 7,293,520, and U.S. Patent Application Publication 2006/0239117 (each of which is hereby incorporated by reference in its entirety, respectively).

As shown in FIG. 1F, the shot distribution from multi-vessel coil shooting is not along one single circle, but along multiple circles. The maximum number of circles is equal to the number of vessels. The pattern of shot distribution may be random, which may be beneficial for imaging and multiple attenuation. Design parameters for multi-vessel coil shooting may include the number of streamers, the streamer separation, the streamer length, the circle radius, the circle roll in X and Y directions, the number of vessels and the relative location of the vessels relative to a master vessel. These parameters may be selected to optimize data distribution in offset-azimuths bins or in offset-vector tiles, and cost efficiency. Those skilled in the art having the benefit of this disclosure will appreciate that these factors can be combined in a number of ways to achieve the stated goals depending upon the objective of and the constraints on the particular survey.

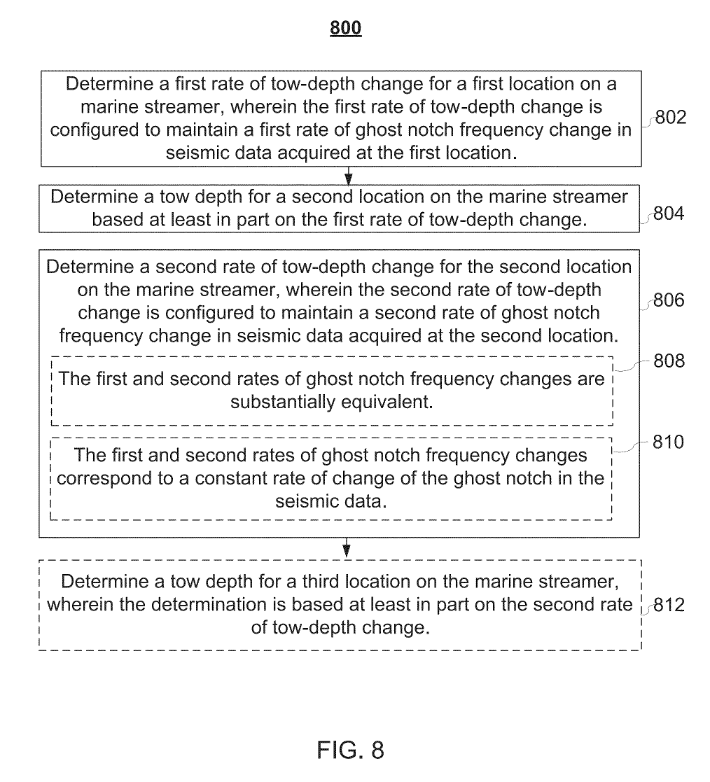

Although the vessel and streamers of FIG. 1F are illustrated as traveling in a generally circular path, in other implementations the vessel and streamers may be steered to travel in a generally oval path, a generally elliptical path, a FIG. 8 path, a generally sine curve path or some combination thereof.

In one implementation, some features and techniques may be employed during a survey, including but not limited to, streamer steering, single-sensor recording, large steerable calibrated source arrays, and improved shot repeatability, as well as benefits such as better noise sampling and attenuation, and the capability to record during vessel turns. Each vessel 143/145/147/149 may include a GPS receiver coupled to an integrated computer-based seismic navigation, source controller, and recording system. In one implementation, sources 120 may include a plurality of air gun sources controlled by one or more controllers adapted to fire respective air guns simultaneously, substantially simultaneously, in user-configurable sequences, or randomly.

Although FIGS. 1F-1G have been described using multiple vessels to perform a coil survey, in other implementations, the coil survey may be performed using a single vessel as described in commonly assigned U.S. Patent Application Publication No. 2008/0285381 (which is hereby incorporated by reference in its entirety). An aerial-view of an implementation of a single vessel marine-based coil survey 185 is illustrated in FIG. 1H.

In a single vessel marine-based coil survey 185, vessel 145 may travel along sail line 171 which is generally circular. Streamer array 121 may then generally follow the circular sail line 171 having a radius R.

In one implementation, sail line 171 may not be truly circular once the first pass is substantially complete. Instead, vessel 145 may move slightly in the y-direction (vertical) value of DY, as illustrated in FIG. 1I. Vessel 145 may also move in the x-direction (horizontal) by a value DX. Note that “vertical” and “horizontal” are defined relative to the plane of the drawing.

FIG. 1I is a computerized rendition of a plan view of the survey area covered by the generally circular sail lines of the coil survey as performed by a multi-vessel marine-based coil survey or a single vessel marine based coil survey over time during a shooting and recording survey. The displacement from circle to circle is DY in the vertical direction and DX in the horizontal direction. As shown in FIG. 1I, several generally circular sail lines cover the survey area. For a single vessel marine-based coil survey, the first generally circular sail line may have been acquired in the southeast corner of the survey. When a first generally circular sail path is completed, vessel 145 may move along the tangent with a certain distance, DY, in vertical direction, and starts a new generally circular path. Several generally circular curved paths may be acquired until the survey border is reached in the vertical direction. A new series of generally circular paths may then be acquired in a similar way, but the origin will be moved with DX in the horizontal direction. This way of shooting continues until the survey area is completely covered.

The design parameters for practicing a single vessel marine-based coil survey may include the radius R of the circle (the radius being a function of the spread width and the coverage fold desired), DY (the roll in the y-direction), and DX (the roll in the x-direction). DX and DY are functions of streamer spread width and of the coverage fold desired to be acquired. The radius R of the circle may be larger than the radius used during the turns and is a function of the streamer spread width. The radius R may range from about 5 km to about 10 km. In one implementation, the radius R ranges from 6 km to 7 km.

As discussed, full-azimuth seismic data can be acquired with a single vessel using circular geometry, or with multiple vessels. A further example of a multi-vessel acquisition configuration 186 that is used currently is depicted in FIG. 1J. While the configuration of FIG. 1J is similar in some respects to FIG. 1F in that two receiver vessels and two source vessels are employed, it is important to note that streamer array 187 is follows the coil sail path. Other type of multiple vessel configurations can be envisaged, such as two streamer vessels and three or four source vessels, or having more than two streamer vessels and more than two or three source vessels. FIG. 1K illustrates a non-limiting example of full azimuth and offset distribution 188 for two streamer vessels and two source vessels.

FIG. 1L conceptually illustrates streamer array 189 as it is towed along a first portion of a coil sail path 190 (which, in FIG. 1L, is offset to the right of the actual sail path for purposes of clarity in the figure). In some embodiments, the first portion of coil sail path 190 corresponds to part of a full sail path of a first vessel in multi-vessel acquisition configuration 186 of FIG. 1J or a coil survey arrangement as illustrated in FIG. 1I.

Significantly, FIG. 1M illustrates that, in some embodiments, a streamer array can be towed at variable depths along the length of the streamer array. The receivers deployed at variable depths along the cable (X-direction) with the constant cable depth in the crossline direction (Y-direction). The receiver depth z1 at the front of the cable is the same for all cables in this embodiment, and the receiver depth z2 at the tail of the cable is the same for all cables. To with, the streamer array is slanted so that the leading edges of respective cables in the streamer array are at a first depth Z1, and the trailing edges of respective cables in the streamer array are at a second depth Z2 that is deeper than first depth Z1. For example, a front cable depth is 12 meters (i.e., depth Z1) for all cables in the streamer array, and the tail cable depth is 32 meters (i.e., depth Z2) for all cables in the streamer array. First depth Z1 and second depth Z2 could have different values that are determined as a function of water depth, geophysical objectives of the seismic survey, and other considerations pertinent to the survey as those with skill in the art will appreciate.

In additional embodiments, FIG. 1N illustrates where receivers on cables in the streamer array are deployed at variable depths along the streamer cable (i.e., the X-direction) and cables in the streamer array are deployed at variable depths in the crossline direction (i.e., the Y-direction). For example, the depth of the receivers along a reference cable (or first streamer in the streamer array) varies from a first depth Z1 (e.g., 8 meters) at the front of a reference cable to a second depth Z2 (e.g., 28 meters) at the tail of the reference cable; similarly, the depth of the receivers for the last streamer may range from a third depth Z3 (e.g. 18 meters) at the front end, to a fourth depth Z4 (e.g., 38 meters) at the tail of the last streamer.

FIG. 1O illustrates a non-limiting example of a slant streamer array in a perspective context. Streamer array 191 includes four streamers 191-1 through 191-4 that are towed along a sail path, which in some embodiments may be oriented along a coil. Z-axis 192, which corresponds to depths relative to surface 193, has depth markers 192-1 through 192-5, indicating increasing depth. Each streamer in array 191 is decreasing in depth from the leading edge to the trailing end of the streamer's cable (e.g., reference streamer 191-1's leading edge is at 191-1a which is between depth 192-1 and 192-2; the middle of streamer 191-1 is at depth 192-2 and thus lower than 191-1a; and the trailing end of streamer 191-1 is below depth 192-2, and thus lower than both 191-1a and 191-1b). Further, each streamer in the array 191 is deeper than its preceding neighbor, (e.g., reference streamer 191-1 is the most shallow with respect to surface 193; streamer 191-2 is deeper than streamer 191-1, etc.)

FIG. 1P illustrates a non-limiting example of a coil-slant streamer array in a perspective context. Streamer array 193 is being towed in a coil sail path (e.g., which in some embodiments may be similar to that shown in FIG. 1L coil sail path 190), and array 193 includes streamers 193-1 through 193-10 (only 193-1 and -10 of the array are labeled for purposes of clarity in the figure). Further, streamer array 193 is being towed at a slant so there is varying depth in the array (e.g., streamer 193-1 is configured to correspond to a continuously decreasing slope, as noted in the example points of a few positions on the cable 193-1a, 193-1b, and 193-1c, which are at approximate depths of 14, 20, and 32 meters, respectively). While the example of FIG. 1P illustrates that the leading edge of each of streamers 193-1 through 193-10 in array 193 are deployed at a first depth (similar to the slant arrangement of FIG. 1M), in some embodiments, array 193 can be towed in a coil-slant arrangement where the array is deployed where the leading edges of the streamers are at varying depths (similar to the slant arrangement of FIG. 1N).

Some benefits to using a slant and/or slant-coil deployment of a streamer array include: improved low frequency preservation due to deeper cable deployments; variable receiver ghosts from receiver to receiver: this feature will facilitate receiver ghost attenuation; improved signal-to-noise ratio due to deeper cable deployments; and full azimuth acquisition due to coil shooting geometry, though those with skill in the art will appreciate that many benefits may occur when using such an acquisition geometry.

Attention is now directed to additional characteristics and operations of towed marine seismic survey acquisition systems. In general terms, the marine towed streamer seismic surveying method uses a seismic source to generate a pressure field that propagates in all directions, including a downgoing wavefield through the water into the earth. The downgoing wavefield reflects and/or refracts off of the geological horizons and subsurface features, returns upward through the water, and is recorded by seismic receivers that are disposed in or near one or more towed streamers. This reflected wavefield continues past the receivers to reflect off of the sea-surface; the wavefield reflected from the sea-surface both positively and negatively interferes with the reflected wavefield overall. The sea-surface reflection is often called the ghost response or ghost wave (see e.g., sea-surface ghost wave 129 in FIG. 1A and accompanying description of FIG. 1A herein for additional description and details).

The marine towed streamer seismic surveying method captures a reflection measurement that is limited in bandwidth by the ghost response. The response of this interfering effect is related to both the tow depth and the source to receiver offset/incident angle.

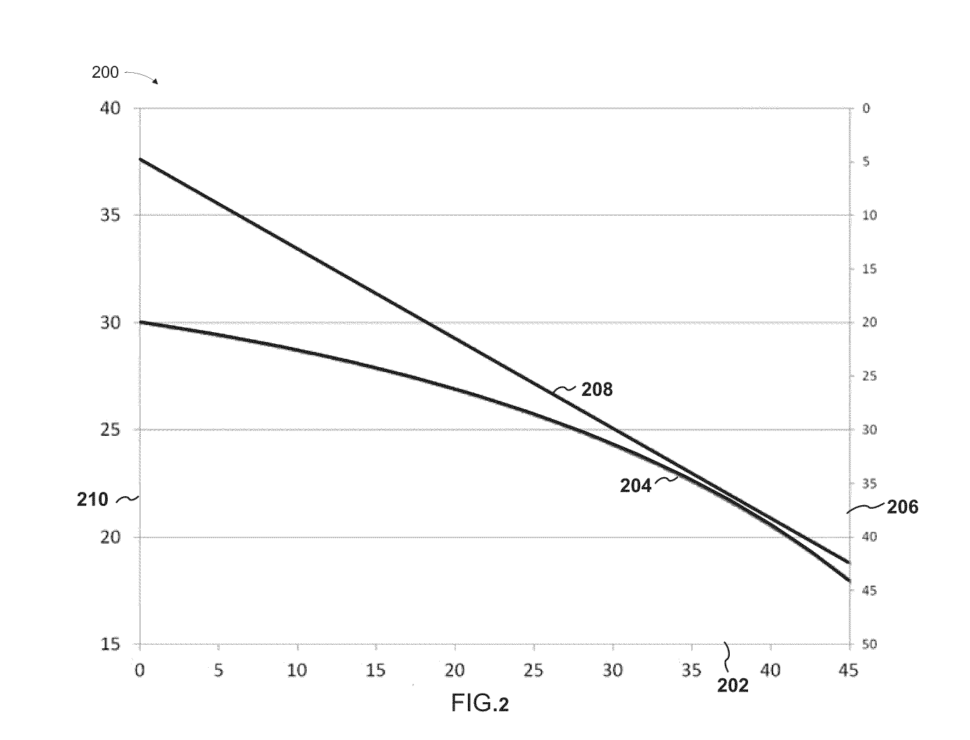

In some embodiments, a marine streamer tow configuration tows a streamer (or a plurality of streamers) in which the ghost notch frequency varies linearly (or substantially linearly) as a function of offset between a seismic source and the seismic receivers disposed in or with the streamer or as a function of incident angle of the travel path of the seismic wavefront (also called ray path herein) emanated from the seismic source (and reflected by specific geologic features, including, for example, the geological target) and the seismic receivers disposed in or with the streamer. (see, e.g., FIG. 2, which is an example plot 200 illustrating the offset dependent receiver depth required to maintain a ghost response that increases linearly as a function of offset (x-axis 202). Plot line 204 details the receiver depth as a function of offset (right side y-axis 206) and plot line 208 illustrates the resulting notch frequency response (left side y-axis 210) which is increasing linearly as a function of offset).

In some embodiments, one or more towed marine seismic streamers are deployed, and the streamer tow depth is maintained with active steering, (e.g., with birds, dampers, and/or other suitable techniques) to ensure that the receiver ghost response frequency varies linearly as a function of the offset between a seismic source and a plurality of towed marine seismic receivers. In some embodiments, this includes using a measurement in which the ghost notch frequency varies linearly as a function of offset or angle between A and B, where A=2*B, over the desired offset or angle range. In some embodiments, this includes using a measurement in which the ghost notch frequency varies linearly as a function of offset or angle from A to B, where A=2*B, over specific subsets of the required offset or angle range. In some embodiments, this includes a measurement in which the polarity of the linear notch frequency gradient is different for the different subsets of the required offset or angle range. In varying embodiments, maintenance of the streamer depth can be based on one or more of the following: the ghost response as would be measured in real time (i.e. no timing perturbations due to required processing steps), after normal move-out correction, after migration, or after other normal seismic processing steps those with skill in the art will appreciate. In some embodiments, the notch response of a particular target reflector (e.g., the geological target) measured in real time will be used to compute and apply corrections to the tow depth so the measured notch response varies linearly as a function of offset or incident angle. In a further embodiment, the notch response of a particular target reflector (e.g., the geological target), after application of one or more typical seismic data processing steps, will be used to compute and apply corrections to the tow depth so that the processed notch response varies linearly as a function of offset or incident angle.

Attention is now directed to a method 300 for computing receiver tow depths along a marine seismic streamer that will establish (or elicit, generate, condition, or bring about) a linear change in notch frequency in received seismic data, where the linear change is a function of offset between a seismic source and the streamer, or as a function of the incident angle of ray paths emitted from a seismic source and received at the streamer. In varying embodiments, this change could be based on straight ray assumptions, curved ray assumptions (i.e. assuming a linear change in p-wave velocity as a function of depth) and/or ray tracing, or other suitable assumptions or processing techniques.

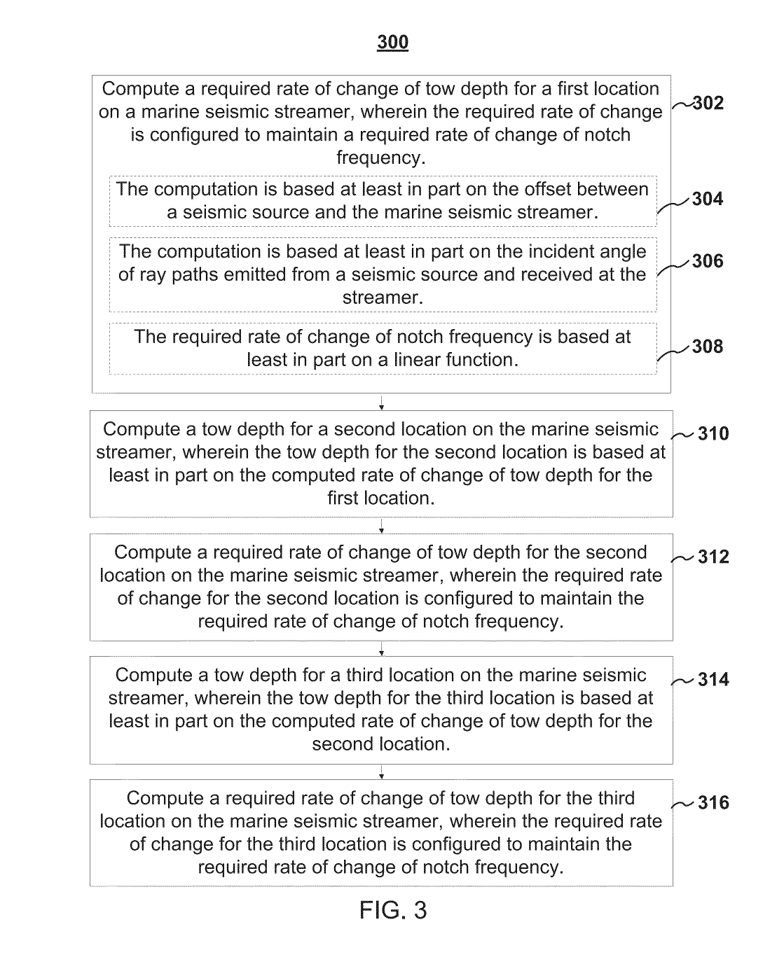

A non-limiting example implementation of this method as applied to a single streamer is illustrated in FIG. 3.

Method 300 includes computing (302) a required rate of change of tow depth for a first location on a marine seismic streamer, wherein the required rate of change is configured to maintain a required rate of change of notch frequency.

In some embodiments, the computation is based at least in part on the offset between a seismic source and the marine seismic streamer (304).

In some embodiments, the computation is based at least in part on the incident angle of ray paths emitted from a seismic source and received at the streamer (306).

In some embodiments, the required rate of change of notch frequency is based at least in part on a linear function (308). For example, a linear rate of change of notch frequency is maintained as a function of offset or incident angle in order to maintain consistent notch diversity. Accordingly, in some embodiments, method 300 can be used to compute a marine seismic streamer shape which maintains a linear variation of notch frequency as a function of offset. Moreover, in some embodiments, method 300 can be used to compute a marine seismic streamer shape to maintain other rates of change of notch frequency based at least in part on offset or incident angle. For example, some embodiments of method 300 compute a marine seismic streamer shape that maintains a constant notch frequency with offset or incident angle.

Method 300 also includes computing a tow depth for a second location on the marine seismic streamer, wherein the tow depth for the second location is based at least in part on the computed rate of change of tow depth at the first location (310).

Method 300 also includes computing a required rate of change of tow depth for the second location on the marine seismic streamer, wherein the required rate of change for the second location is configured to maintain the required rate of change of notch frequency (312).

Method 300 also includes computing a tow depth for a third location on the marine seismic streamer, wherein the tow depth for the third location is based at least in part on the computed rate of change of tow depth at the second location (314).

Method 300 also includes computing a required rate of change of tow depth for the third location on the marine seismic streamer, wherein the required rate of change for the third location is configured to maintain the required rate of change of notch frequency (316).

As those with skill in the art will appreciate, the example of FIG. 3 and method 300 describes a method for setting tow depths and rates of change for three positions on a streamer. Nevertheless, computations in method 300 can be iteratively performed for locations along the length of one or more marine seismic streamer(s) so that particular tow depths and associated rates of tow depth changes for respective locations on the streamer(s) can be calculated so as to generate a streamer shape profile and set of tow depth change instructions for maintaining a streamer shape profile (or profiles of respective streamers in an array, wherein individual streamer shape profiles in an array may vary, e.g., a first streamer in an array may be configured to be towed with a first shape profile, a second streamer in the array may be configured to be towed with a second shape profile that is different than the first shape profile, etc.).

Moreover, in some embodiments, the set of tow depth change instructions for maintaining a streamer shape profile (or a set of tow depth change instructions for maintaining a shape profile for an array of marine seismic streamers) is provided to (or prepared by) a computing system that is configured to provide active steering instruction to one or more streamer control devices.

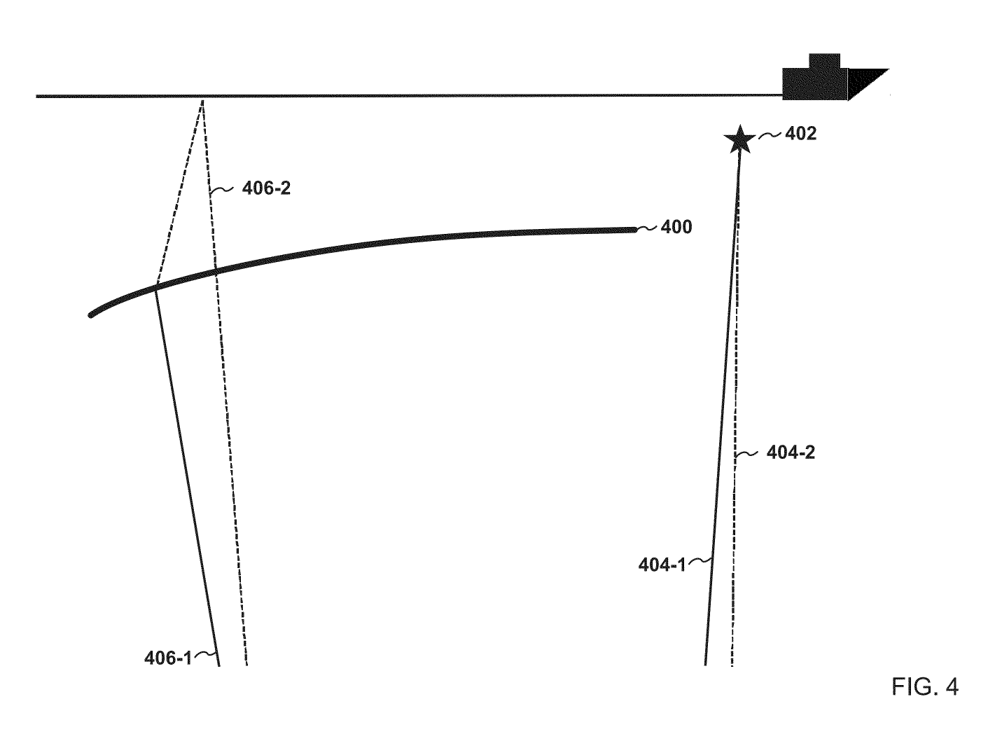

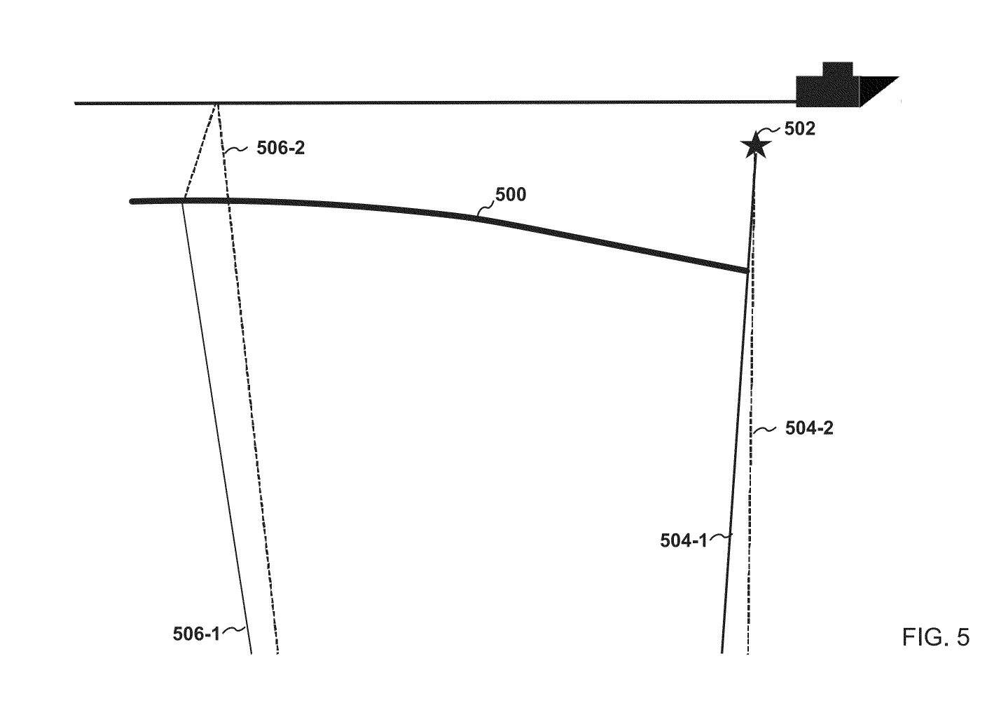

Attention is now directed to FIGS. 4 and 5, which are diagrams illustrating examples of offset dependent streamer depth towing in accordance with some embodiments. In the example of FIG. 4, the streamer cable 400 has a shape that deepens with increasing offset from the seismic source 402 (i.e., the distal end of the cable is deeper than the proximate end). A downgoing wavefront 404 travels from source 402, and in FIG. 4, downgoing rays 404-1 and 404-2 associated with what will be received as a primary signal and a ghost signal, respectively, are illustrated. While not illustrated in FIG. 4, a reflective surface, such as a subterranean horizon beyond the edge of the figure, reflects wavefront 404 and primary signal 406-1 and ghost signal 406-2 arrive at streamer 400.

In the example of FIG. 5, the streamer cable shape 500 shallows with increasing offset from the seismic source 502 (i.e., the distal end of the cable is shallower than the proximate end). A downgoing wavefront 504 travels from source 502, and in FIG. 5, downgoing rays 504-1 and 504-2 associated with what will be received as a primary signal and a ghost signal, respectively, are illustrated. While not illustrated in FIG. 5, a reflective surface, such as a subterranean horizon beyond the edge of the figure, reflects wavefront 504 and primary signal 506-1 and ghost signal 506-2 arrive at streamer 500.

Offset dependent streamer depths for configurations such as those examples illustrated in FIGS. 4 and 5 may be computed and maintained, (e.g., via active steering), so that in some embodiments, the inverse of the difference of a ghost travel path travel time and a primary travel path travel time varies linearly as a function of offset; whereas in alternate embodiments, the inverse of the difference of a ghost travel path travel time and a primary travel path travel time varies constantly as a function of incident angle. In some embodiments, the offset dependent streamer depth may be computed and maintained, (e.g., via active steering), so that the speed of sound in water divided by the difference between the primary and ghost travel path distance varies linearly as a function of offset; whereas in alternate embodiments, the speed of sound in water divided by the difference between the primary and ghost travel path distance varies linearly as a function of incident angle.

As those with skill in the art will appreciate, seismic surveys carried out in accordance with some embodiments disclosed herein may be performed where one or more streamers in an array may be towed with offset dependent streamer depths where a first streamer in the array of streamers is towed at a first depth and a second streamer in the array of streamers is towed at a second depth different than the first depth. Moreover, in some embodiments, one or more streamers in an array may be towed where a first streamer in the array of streamers is towed with a first streamer shape to maintain one notch frequency gradient as a function of offset or angle, and a second streamer in the array of streamers is towed with a second streamer shape to maintain a second notch frequency gradient as a function of offset or angle. Varying depth of a streamer array in different directions may be referred to as a slant acquisition configuration, and can be used in conjunction with various embodiments disclosed herein for maintaining notch frequencies. Additionally, in some embodiments, the use of active steering may enable the array of streamers to be used in a coil acquisition with offset dependent streamer depths. In some embodiments, the use of active steering may enable the array of streamers to be used in a coil acquisition while the array is towed in a slant acquisition configuration with offset dependent streamer depths.

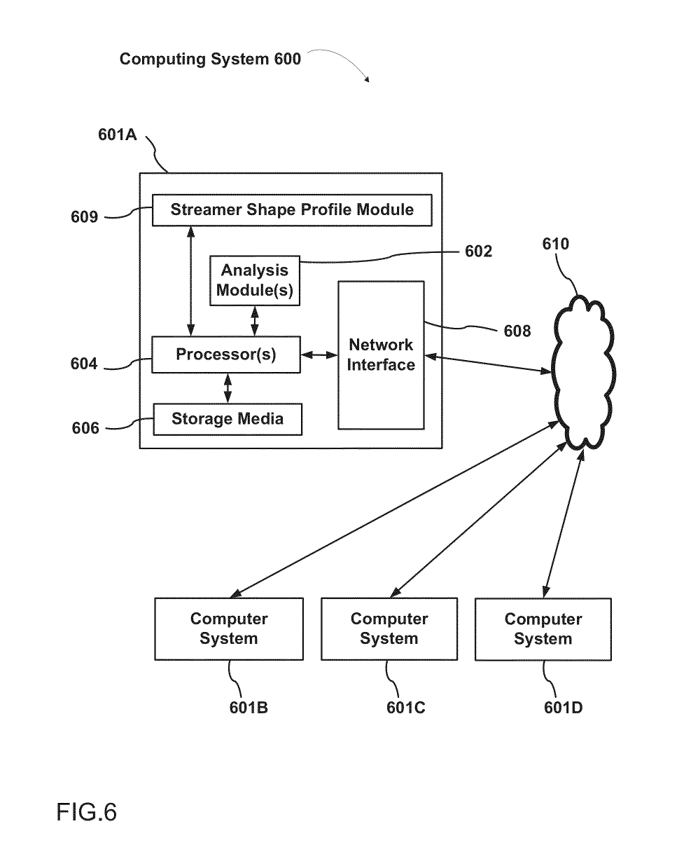

Attention is now directed to FIG. 6, which depicts an example computing system 600 in accordance with some embodiments. The computing system 600 can be an individual computer system 601A or an arrangement of distributed computer systems. The computer system 601A includes one or more analysis modules 602 that are configured to perform various tasks according to some embodiments, such as one or more methods and/or workflows and/or algorithms disclosed herein, and/or combinations and/or variations thereof. To perform these various tasks, analysis module 602 executes independently, or in coordination with, one or more processors 604, which is (or are) connected to one or more storage media 606A. The processor(s) 604 is (or are) also connected to a network interface 608 to allow the computer system 601A to communicate over a data network 610 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be on a ship underway on the ocean, while in communication with one or more computer systems such as 601C and/or 601D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 606A can be implemented as one or more computer-readable or machine-readable storage media. Note that while in the example embodiment of FIG. 6 storage media 606A is depicted as within computer system 601A, in some embodiments, storage media 606A may be distributed within and/or across multiple internal and/or external enclosures of computing system 601A and/or additional computing systems. Storage media 606A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs), digital video disks (DVDs), BluRays, or other optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 600 contains one or more streamer shape profile module(s) for determining, calculating, estimating, and/or deriving a streamer tow-depth profile. In conjunction with other equipment such as streamer steering equipment, the streamer shape profile module is in part responsible for configuring a streamer (and thus, a plurality of seismic receivers) to acquire seismic data having a receiver ghost response frequency that varies linearly. In the example of computing system 600, computer system 601A includes streamer shape profile module 609. In some embodiments, a single streamer shape profile module may be used to determine respective streamer shape profiles for respective streamers in a plurality of streamers. In alternate embodiments, respective streamer shape profile modules may be used to determine respective streamer shape profiles for respective streamers in a plurality of streamers.

While not illustrated in FIG. 6, in some embodiments, streamer shape profile module 609 may receive input from streamer steering equipment, wherein the received input is used for calculating tow-depth profile(s) for one or more streamers. In some embodiments, streamer shape profile module 609 may receive input directly from streamer steering equipment via communication links not illustrated. In alternate embodiments, streamer shape profile module 609 may receive input indirectly from streamer steering equipment via the computer system that streamer shape profile module 609 is disposed in.

It should be appreciated that computing system 600 is only one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more processors, signal processors, microcontrollers, programmable logic devices, application specific integrated circuits, and/or other appropriate processing equipment.

It should also be appreciated that in the example of computing system 600, computer system 601A includes links between various modules, e.g., a link between analysis module(s) 602 and processor(s) 604, this is a non-limiting example, and many computer system architectures are possible and encompassed by the embodiments disclosed herein.

Attention is now directed to example mathematical expressions that can be used to implement various embodiments disclosed herein.

The notch frequency is a function of source to receiver offset, or incident angle, and the tow depth plus a number of other factors related to the earth geology. For the purposes of explanation only, one can describe the notch frequency in terms of tow depth, which is correct for the zero offset case.

$$\frac{1}{Nf} = Fn ( Zrx )$$

where Nf=notch frequency and Zrx=receiver depth.

By differentiating this relationship we obtain a relationship:

$$- Nf * \frac{d Nf}{d X} = Fn ( \frac{d Zrx}{d X} )$$

which relates the rate of change of notch frequency to the rate of change of tow depth. For a rate of change of notch frequency, it is possible to compute the rate of change of tow depth. In this non-limiting example, we have differentiated with respect to source to receiver offset, but as those with skill in the art will appreciate, one can also differentiate with respect to incident angle.

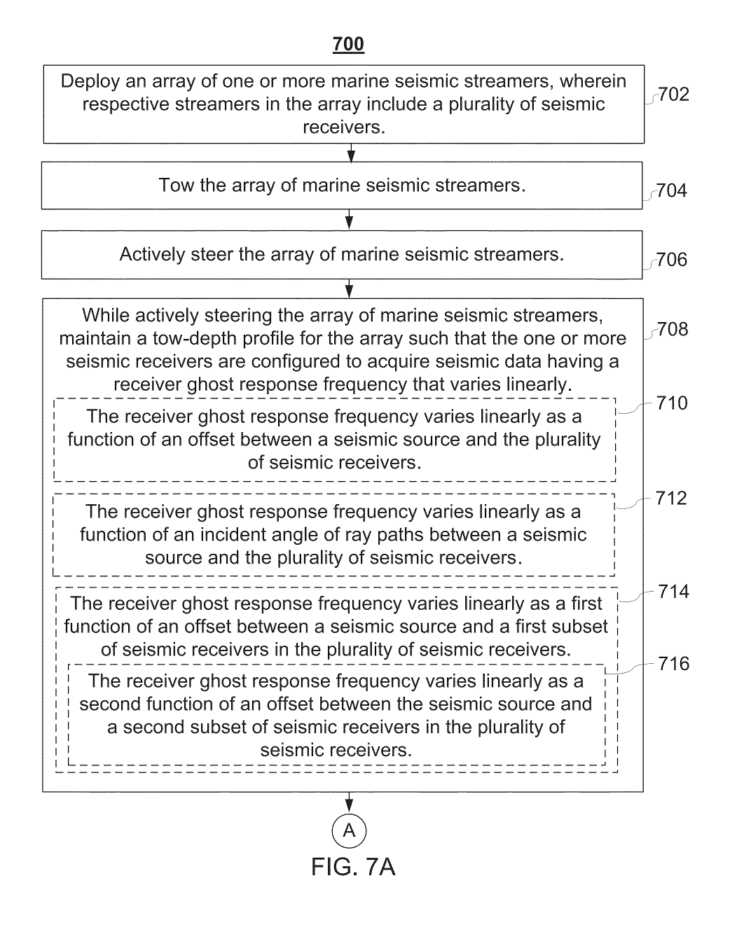

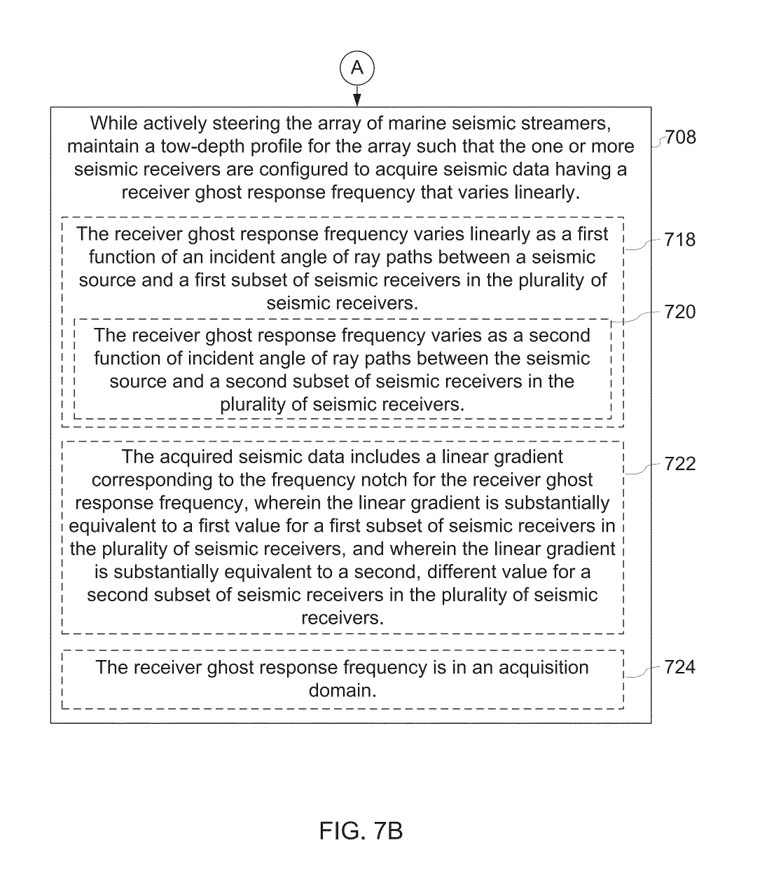

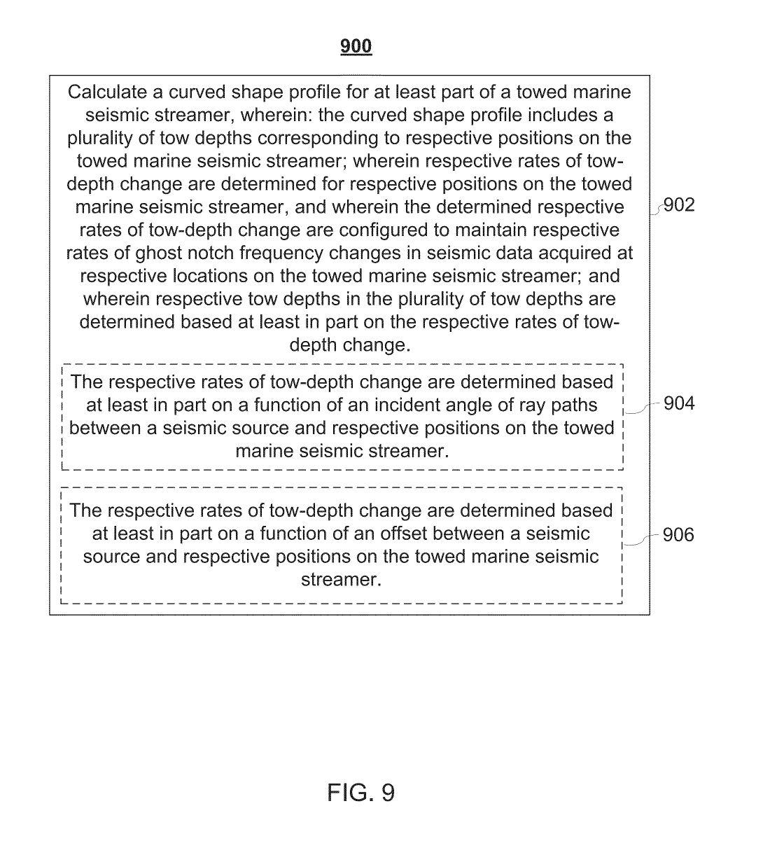

Attention is now directed to FIGS. 7A and 7B, which are flow diagrams illustrating method 700 for performing a marine seismic survey in accordance with some embodiments. Some operations in method 700 may be combined and/or the order of some operations may be changed. Further, some operations in method 700 may be combined with aspects of the example methods of FIGS. 3, 8 and/or FIG. 9, and/or the order of some operations in method 700 may be changed to account for incorporation of aspects of the methods illustrated by FIGS. 3, 8 and/or 9.

Some aspects of method 700 may be performed at a computing system, such as the example computing system 600 illustrated in FIG. 6.

Method 700 includes deploying (702) an array of one or more marine seismic streamers, wherein respective streamers in the array include a plurality of seismic receivers.

Method 700 also includes towing (704) the array of marine seismic streamers.

Method 700 also includes actively steering (706) the array of marine seismic streamers.

Method 700 also includes that, while actively steering the array of marine seismic streamers, a tow-depth profile is maintained (708) for the array such that the one or more seismic receivers are configured to acquire seismic data having a receiver ghost response frequency that varies linearly.

In some embodiments, the receiver ghost response frequency varies linearly as a function of an offset between a seismic source and the plurality of seismic receivers (710).

In some embodiments, the receiver ghost response frequency varies linearly as a function of an incident angle of ray paths between a seismic source and the plurality of seismic receivers (712).

In some embodiments, the receiver ghost response frequency varies linearly as a first function of an offset between a seismic source and a first subset of seismic receivers in the plurality of seismic receivers (714). In some embodiments, the receiver ghost response frequency varies linearly as a second function of an offset between the seismic source and a second subset of seismic receivers in the plurality of seismic receivers (716).

In some embodiments, the receiver ghost response frequency varies linearly as a first function of an incident angle of ray paths between a seismic source and a first subset of seismic receivers in the plurality of seismic receivers (718). In some embodiments, the receiver ghost response frequency varies as a second function of incident angle of ray paths between the seismic source and a second subset of seismic receivers in the plurality of seismic receivers (720).

The acquired seismic data includes a linear gradient corresponding to the frequency notch for the receiver ghost response frequency, wherein the linear gradient is substantially equivalent to a first value for a first subset of seismic receivers in the plurality of seismic receivers, and wherein the linear gradient is substantially equivalent to a second, different value for a second subset of seismic receivers in the plurality of seismic receivers (722).

In some embodiments, the receiver ghost response frequency is in an acquisition domain (724).

Attention is now directed to FIG. 8, which is a flow diagram illustrating method 800 for determining a marine seismic streamer shape profile in accordance with some embodiments. Some operations in method 800 may be combined and/or the order of some operations may be changed. Further, some operations in method 800 may be combined with aspects of the example methods of FIGS. 3, 7 and/or FIG. 9, and/or the order of some operations in method 800 may be changed to account for incorporation of aspects of the methods illustrated by FIGS. 3, 7 and/or 9.

Some aspects of method 800 may be performed at a computing system, such as the example computing system 600 illustrated in FIG. 6.

Method 800 includes determining (802) a first rate of tow-depth change for a first location on a marine streamer, wherein the first rate of tow-depth change is configured to maintain a first rate of ghost notch frequency change in seismic data acquired at the first location. The rate of tow-depth change directly affects the streamer shape so as to help create an overall streamer profile, such as those examples illustrated in FIGS. 4 and 5.

Method 800 also includes determining (804) a tow depth for a second location on the marine streamer based at least in part on the first rate of tow-depth change.

In some embodiments, method 800 also includes determining a second rate of tow-depth change for the second location on the marine streamer, wherein the second rate of tow-depth change is configured to maintain a second rate of ghost notch frequency change in seismic data acquired at the second location (806).

In some embodiments, the first and second rates of ghost notch frequency changes are substantially equivalent (808).

In some embodiments, the first and second rates of ghost notch frequency changes correspond to a constant rate of change of the ghost notch in the seismic data (810).

In some embodiments, method 800 also includes determining (812) a tow depth for a third location on the marine streamer, wherein the determination is based at least in part on the second rate of tow-depth change.

Attention is now directed to FIG. 9, which is a flow diagram illustrating method 900 for determining a marine seismic streamer shape profile in accordance with some embodiments. Some operations in method 900 may be combined and/or the order of some operations may be changed. Further, some operations in method 900 may be combined with aspects of the example methods of FIGS. 3, 7 and/or FIG. 8, and/or the order of some operations in method 800 may be changed to account for incorporation of aspects of the workflow illustrated by FIGS. 3, 7 and/or FIG. 8.

Some aspects of method 900 may be performed at a computing system, such as the example computing system 600 illustrated in FIG. 6.

Method 900 includes calculating (902) a curved shape profile for at least part of a towed marine seismic streamer, wherein: the curved shape profile includes a plurality of tow depths corresponding to respective positions on the towed marine seismic streamer; wherein respective rates of tow-depth change are determined for respective positions on the towed marine seismic streamer, and wherein the determined respective rates of tow-depth change are configured to maintain respective rates of ghost notch frequency changes in seismic data acquired at respective locations on the towed marine seismic streamer; and wherein respective tow depths in the plurality of tow depths are determined based at least in part on the respective rates of tow-depth change.

In some embodiments, the respective rates of tow-depth change are determined based at least in part on a function of an incident angle of ray paths between a seismic source and respective positions on the towed marine seismic streamer (904).

In some embodiments, the respective rates of tow-depth change are determined based at least in part on a function of an offset between a seismic source and respective positions on the towed marine seismic streamer (906).

The steps in the methods described herein, including controlling steering of streamers to control streamer shape, may be implemented by running one or more functional modules in computing systems, or in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
deploying an array of one or more marine seismic streamers, wherein respective streamers in the array include a plurality of seismic receivers;
towing the array of marine seismic streamers;
actively steering the array of marine seismic streamers; and
while actively steering the array of marine seismic streamers, maintaining a tow-depth profile for the array such that the plurality of seismic receivers are configured to acquire seismic data having a receiver ghost response frequency that varies linearly.

2. The method of claim 1, wherein the receiver ghost response frequency varies linearly as a function of an offset between a seismic source and the plurality of seismic receivers.

3. The method of claim 1, wherein the receiver ghost response frequency varies linearly as a function of an incident angle of ray paths between a seismic source and the plurality of seismic receivers.

4. The method of claim 1, wherein the receiver ghost response frequency varies linearly as a first function of an offset between a seismic source and a first subset of seismic receivers in the plurality of seismic receivers.

5. The method of claim 4, wherein the receiver ghost response frequency varies linearly as a second function of an offset between the seismic source and a second subset of seismic receivers in the plurality of seismic receivers.

6. The method of claim 1, wherein the receiver ghost response frequency varies linearly as a first function of an incident angle of ray paths between a seismic source and a first subset of seismic receivers in the plurality of seismic receivers.

7. The method of claim 6, wherein the receiver ghost response frequency varies as a second function of incident angle of ray paths between the seismic source and a second subset of seismic receivers in the plurality of seismic receivers.

8. The method of claim 1, wherein the acquired seismic data includes a linear gradient corresponding to the frequency notch for the receiver ghost response frequency,
wherein the linear gradient is substantially equivalent to a first value for a first subset of seismic receivers in the plurality of seismic receivers, and
wherein the linear gradient is substantially equivalent to a second, different value for a second subset of seismic receivers in the plurality of seismic receivers.

9. The method of claim 1, wherein the receiver ghost response frequency is in an acquisition domain.

10. A method, comprising:
at a computing system:
determining a first rate of tow-depth change for a first location on a marine streamer, wherein the first rate of tow-depth change is configured to maintain a first rate of ghost notch frequency change in seismic data acquired at the first location; and
based at least in part on the first rate of tow-depth change, determining a tow depth for a second location on the marine streamer.

11. The method of claim 10, further comprising determining a second rate of tow-depth change for the second location on the marine streamer, wherein the second rate of tow-depth change is configured to maintain a second rate of ghost notch frequency change in seismic data acquired at the second location.

12. The method of claim 11, wherein the first and second rates of ghost notch frequency changes are substantially equivalent.

13. The method of claim 11, wherein the first and second rates of ghost notch frequency changes correspond to a constant rate of change of the ghost notch in the seismic data.

14. The method of claim 11, further comprising determining a tow depth for a third location on the marine streamer, wherein the determination is based at least in part on the second rate of tow-depth change.

15. A computing system, comprising:
at least one processor,
at least one memory, and
one or more programs stored in the at least one memory, wherein the one or more programs comprise instructions, which, when executed by the at least one processor, are configured for:
calculating a curved shape profile for at least part of a towed marine seismic streamer, wherein:
the curved shape profile includes a plurality of tow depths corresponding to respective positions on the towed marine seismic streamer,
respective rates of tow-depth change are determined for respective positions on the towed marine seismic streamer, wherein the determined respective rates of tow-depth change are configured to maintain respective rates of ghost notch frequency changes in seismic data acquired at respective locations on the towed marine seismic streamer, and
respective tow depths in the plurality of tow depths are determined based at least in part on the respective rates of tow-depth change.

16. The computing system of claim 15, wherein the respective rates of tow-depth change are determined based at least in part on a function of an incident angle of ray paths between a seismic source and respective positions on the towed marine seismic streamer.

17. The computing system of claim 15, wherein the respective rates of tow-depth change are determined based at least in part on a function of an offset between a seismic source and respective positions on the towed marine seismic streamer.

18. The computing system of claim 15, wherein the calculation of the curved shape profile is performed at least in part by a streamer shape profile module disposed in the computing system.
